(19) United States
(12) Patent Application Publication
(10) Pub. No.: US 2010/0100756 A1
(43) Pub. Date: Apr. 22, 2010

(54) Power Supply Wear Leveling in a Multiple-PSU Information Handling System

(75) Inventor: Johan Rahardjo, Austin, TX (US)

Correspondence Address: Baker Botts L.L.P, 910 Louisiana Street, One Shell Plaza, HOUSTON, TX, 77002, US

(73) Assignee: DELL PRODUCTS L.P., Round Rock, TX (US)

(21) Appl. No.: 12/254,628

(22) Filed: Oct. 20, 2008

(51) Int. Cl. G06F 1/26

(52) U.S. Cl. 713/330

(57) ABSTRACT

In some embodiments, a method for power supply wear leveling in an information handling system including multiple power supply units (PSUs) is provided. The method includes maintaining each of multiple PSUs in one of multiple different operational states, automatically determining an accumulated on-time for each of the multiple PSUs, ranking the multiple PSUs based on the accumulated on-time determined for each PSU, and automatically changing the operational state of at least one of the PSUs based at least on the ranking of the multiple PSUs.

### TECHNICAL FIELD

The present disclosure relates in general to information handling systems, and more particularly to systems and methods for power supply wear leveling in an information handling system (e.g., a blade server system) having multiple power supply units (PSUs)

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

One type of information handling system is a blade server, or simply “blade.” Blades are often self-contained information handling systems designed specifically to allow the placement of multiple blades in a single enclosure or aggregation of enclosures. A blade enclosure or chassis may hold multiple blades and provide services to the various blades such as power, cooling, networking, interconnects, and management. For example, the chassis may include a plurality of power supply units (PSUs) configured to provide power to blades mounted in the chassis.

A blade server chassis may provide various services shared between the blades in the chassis, including supplying power to the blades and chassis. Information handling systems may operate over a range of DC voltages, yet power is typically delivered from utilities as AC, and at higher voltages than required by the computer. Converting the current from AC to DC may require one or more power supply units (PSUs). To ensure that the failure of one PSU does not affect the operation of the information handling system, a blade chassis may include multiple PSUs to provide redundancy. The PSUs of a blade chassis may provide a single power source for some or all blades within the chassis.

PSUs degrade over time. In existing blade server systems with multiple PSUs, the PSUs are not utilized evenly. For example, a particular PSU may be utilized at 100% duty cycle, and will thus fail first. Although the system may fail-over to a redundant/spare PSU, the failure of the particular PSU may generate a service call/dispatch, which adds time and cost to the operation of the system.

### SUMMARY

In accordance with the teachings of the present disclosure, certain disadvantages and problems associated with power supply wear in an information handling system, e.g., a blade server chassis, have been substantially reduced or eliminated.

According to certain embodiments of the present disclosure, a method for power supply wear leveling in an information handling system including multiple power supply units (PSUs) is provided. The method includes maintaining each of multiple PSUs in one of multiple different operational states, automatically determining an accumulated on-time for each of the multiple PSUs, ranking the multiple PSUs based on the accumulated on-time determined for each PSU, and automatically changing the operational state of at least one of the PSUs based at least on the ranking of the multiple PSUs.

According to certain embodiments of the present disclosure, an information handling system includes multiple power supply units (PSUs), each maintained in one of multiple different operational states, and a chassis management controller (CMC) coupled to each of the PSUs. The CMC is configured to maintain each of multiple PSUs in one of multiple different operational states, automatically determine an accumulated on-time for each of the multiple PSUs, rank the multiple PSUs based on the accumulated on-time determined for each PSU, and automatically change the operational state of at least one of the PSUs based at least on the ranking of the multiple PSUs.

According to certain embodiments of the present disclosure, logic instructions for wear leveling in an information handling system including multiple power supply units (PSUs) are provided. The logic instructions are embodied in tangible computer readable media and executable by a processor. The logic instructions include instructions for maintaining each of multiple PSUs in one of multiple different operational states; instructions for automatically determining an accumulated on-time for each of the multiple PSUs; instructions for ranking the multiple PSUs based on the accumulated on-time determined for each PSU; and instructions for automatically changing the operational state of at least one of the PSUs based at least on the ranking of the multiple PSUs.

### BRIEF DESCRIPTION OF THE DRAWINGS

A more complete understanding of the disclosed embodiments and advantages thereof may be acquired by referring, by way of example, to the following description taken in conjunction with the accompanying drawings, in which like reference numbers indicate like features, and wherein:

FIG. 1 illustrates an example embodiment of an information handling system including multiple PSUs and a system for PSU wear leveling, in accordance with certain embodiments of the present disclosure;

FIG. 2 illustrates an example method for wear leveling in an information handling system having multiple PSUs, according to certain embodiments of the present disclosure; and

FIG. 3 illustrates an example method for wear leveling in an information handling system having multiple PSUs in a configuration with multiple spare PSUs, according to certain embodiments of the present disclosure.

### DETAILED DESCRIPTION

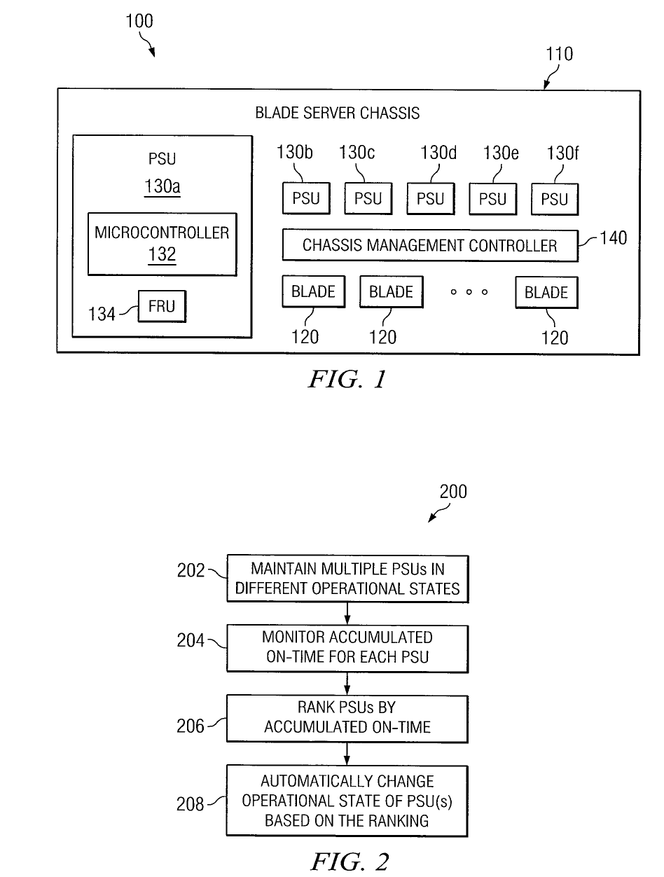

Preferred embodiments and their advantages are best understood by reference to FIGS. 1-3.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network storage device, or any other suitable device and may vary in size, shape, performance, functionality, and price. The information handling system may include memory, one or more processing resources such as a central processing unit (CPU) or hardware or software control logic. Additional components or the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such wires, optical fibers, microwaves, radio waves, and other electromagnetic and/or optical carriers; and/or any combination of the foregoing.

For the purposes of this disclosure, a power supply unit (PSU) is a device or system that supplies electrical or other types of energy to an output load or group of loads. For example, a PSU for an information handling system may be a piece of hardware designed to convert AC power from the grid to low-voltage DC power outputs for internal components of the information handling system. As another example, a PSU may comprise a battery.

FIG. 1 illustrates an example embodiment of an information handling system 100 including multiple PSUs and a system for PSU wear leveling, in accordance with certain embodiments of the present disclosure. In this example, information handling system 100 is a blade server chassis 100 including a housing 110, multiple blades 120, six PSUs 130, a chassis management controller (CMC) 140, and any other suitable information handling system components (e.g., fan modules, I/O modules, etc.). It should be understood that although a blade server chassis 100 with six PSUs 130a-130f and one CMC 140 is illustrated, the wear leveling concepts disclosed herein may be applied to any other type of information handling system including any number of multiple PSUs and any number of CMCs or other suitable control system(s).

Blades 120 may be arranged in any suitable manner within housing 110. For example, blades 120 may be arranged in rows and/or stacks.

PSUs 130 may include any devices configured to provide power for components of blade server chassis 100. For example, each PSU 130 may be capable of delivering 2360 Watts of power at 12 Volts DC. A PSU 130 may take in single phase 180 to 264 v AC and convert it to 12 v DC to supply to components within blade server chassis 100. A certain number of PSUs 130 may provide enough power for a fully loaded blade server chassis 100; however, a blade server chassis 100 may hold more PSUs 130 to support redundant power modes, such as AC or DC redundant modes. For example, in the illustrated embodiment, three PSUs may provide enough power for a fully loaded blade server chassis 100, but six PSUs 130a-130f may be provided to support redundant power modes.

Thus, at any given time, one or more PSUs 130 may be designated as “active” PSUs and turned on (i.e., currently supplying power to system 100), while one or more other PSUs 130 may be designated as “spare” PSUs and turned off (i.e., not currently supplying power to system 100). The number of spare PSUs vs. active PSUs may be determined based on any suitable parameters, e.g., to maximize system efficiency. For example, because certain PSUs achieve maximum efficiency at around 80% load, the number of spare PSUs vs. active PSUs may be determined such that the active PSUs are at around 80% load.

As used herein, a PSU is active if the PSU is turned “on.” A PSU is “on” in any operational state (e.g., on, active, online, etc.) in which the PSU is providing power to system 100. Conversely, a PSU is inactive if the PSU is turned “off.” A PSU is “off” in any operational state (e.g., off, inactive, offline, standby, sleep, etc.) in which the PSU is not providing power to system 100.

Power may be provided to PSUs 130 from one or more Power Distribution Units (PDUs). The PDUs, in turn, may be provided power from a main AC power source or uninterruptible power source though an inlet cord of the PDU.

CMC 140 may perform power monitoring and/or power management for the system 100, including monitoring and controlling PSUs 130. Such functionality may include, for example, maintaining each PSU 130 in one of multiple different operational states, automatically determining an accumulated on-time for each PSU 130, ranking the multiple PSUs 130 based at least on the accumulated on-time determined for each PSU 130, and automatically changing the operational state of at least one of the PSUs 130 based at least on the ranking of the multiple PSUs 130.

CMC 140 may include, or have access to, any suitable hardware, software, and/or firmware for providing any of the functionality discussed herein. For example, CMC 140 may include, or have access to a processor and logic instructions (e.g., software and/or firmware) encoded in computer readable media and executable by the processor to provide any of the functionality discussed herein.

In operation, CMC 140 may automatically monitor the accumulated on-time for each PSU 130. The accumulated on-time for a PSU 130 may represent the total time that the PSU 130 has been turned on over the life of the PSU 130 (or over the period of time that the PSU 130 has been installed in system 100). CMC 140 may monitor the accumulated on-time for each PSU 130 in any suitable manner. For example, CMC 140 may read the accumulated on-time of each PSU 130 through PMBus command to the PSU's microcontroller 132, or through I²C command to the PSU's field replaceable unit (FRU) 134.

CMC 140 may then rank each of the PSUs 130 based on the accumulated on-time determined for each PSU 130. Based on the ranking, CMC 140 may then determine one or more PSUs to turn on and/or one or more PSUs to turn off.

For example, CMC 140 may identify the PSU having the lowest accumulated on-time and the PSU having the highest accumulated on-time. CMC 140 may then turn on the identified lowest on-time PSU, wait for it to stabilize, and then turn on the identified highest on-time PSU.

CMC 140 may also manage PSUs in a configuration including multiple spare PSUs. For example, in a configuration including a number (y) spare PSUs, CMC 140 may rank the PSUs according to accumulated on-time, and determine the y highest on-time PSUs and the y lowest on-time PSUs. CMC 140 may then turn on the y lowest on-time PSUs, wait until they stabilize, and then turn off the y highest on-time PSUs.

CMC 140 may perform such power leveling functions at any suitable time, e.g., automatically at regular intervals, automatically upon some triggering event, or in response to a user command.

FIG. 2 illustrates an example method 200 for wear leveling of multiple PSUs in an information handling system 100, according to certain embodiments of the present disclosure.

At step 202, CMC 140 maintains each of the multiple PSUs 130 of system 100 in one of multiple different operational states. For example, in a system with six PSUs, CMC 140 may maintain three PSUs in an active state and the other three in an inactive state.

At step 204, CMC 140 monitors the multiple PSUs 130 to determine the accumulated on-time for each PSU 130. At step 206, CMC 140 ranks the PSUs by accumulated on-time. At step 208, CMC 140 automatically changes the operational state of at least one of the PSUs 130 based at least on the ranking of the PSUs 130. For example, CMC 140 may turn on one or more of the lowest on-time PSUs and turn off one or more of the highest on-time PSUs, based on the rankings. The method may then return to step 202 and the method may repeat with any desired frequency (e.g., periodically or upon some predetermined triggering event).

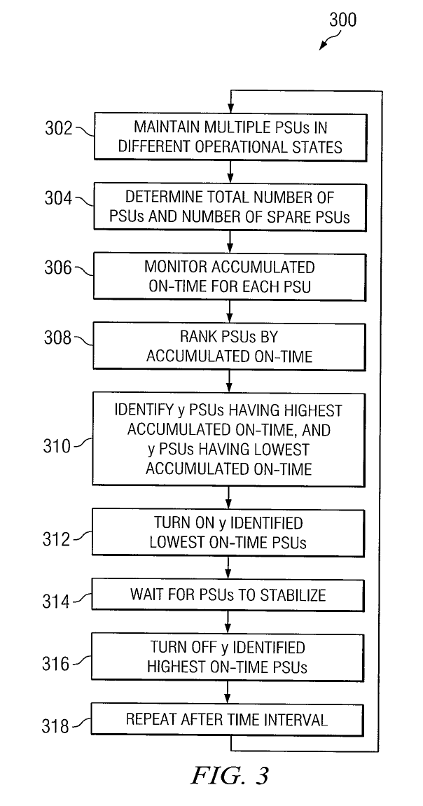

FIG. 3 illustrates an example method 300 for wear leveling of multiple PSUs in an information handling system 100 configured for multiple spare PSUs, according to certain embodiments of the present disclosure.

At step 302, CMC 140 maintains each of the multiple PSUs 130 of system 100 in one of multiple different operational states. For example, in a system with six PSUs, CMC 140 may maintain three PSUs in an active state and the other three in an inactive state.

At step 304, CMC 140 identifies the total number of PSUs in system 100, as well as the number (y) of spare PSUs defined by the particular PSU configuration.

At step 306, CMC 140 monitors the multiple PSUs 130 to determine the accumulated on-time for each PSU 130. For example, CMC 140 may read the on-time of each PSU 130 through PMBus command to the PSU's microcontroller 132, or through I²C command to the PSU's field replaceable unit (FRU) 134.

At step 308, CMC 140 ranks the PSUs by accumulated on-time. At step 310, CMC 140 identifies the y PSUs having the highest accumulated on-time, and the y PSUs having the lowest accumulated on-time. For example, in a 6 PSU configuration with 3 spare PSUs (y=3), CMC 140 identifies the 3 PSUs having the highest accumulated on-time and the 3 PSUs having the lowest accumulated on-time.

At step 312, CMC 140 turns on the identified y lowest on-time PSUs. In the example discussed above, CMC 140 turns on the 3 identified lowest on-time PSUs. At step 314, CMC 140 waits for the PSUs to stabilize after turning on the y lowest on-time PSUs. After the PSUs stabilize, CMC 140 turns off the identified y highest on-time PSUs at step 316. In the example discussed above, CMC 140 turns off the 3 identified highest on-time PSUs. The method may repeat after a predetermined time interval, as indicated at step 318.

Using the wear leveling techniques discussed above, PSU failure and/or accelerated system failure may be reduced, and a more even wear of the PSUs may be achieved, in certain embodiments. For example, mean time between failure (MTBF) of PSUs may increase. This may be particularly important in a blade modular system, as the chassis/PSUs may have a lifetime of several or many years (e.g., a user may upgrade the blades over time but keep the same chassis/PSUs). In addition, the reliability of an information handling systems may be improved, and the need for service calls and/or warranty costs may be reduced.

Using the methods and systems disclosed herein, certain problems associated with power supplies for information handling systems, such as for example blade server systems may be improved, reduced, or eliminated.

Although the present disclosure has been described in detail, it should be understood that various changes, substitutions, and alterations can be made hereto without departing from the spirit and the scope of the disclosure as defined by the appended claims.

What is claimed is:

1. A method for power supply wear leveling in an information handling system including multiple power supply units (PSUs), the method comprising:
maintaining each of multiple PSUs in one of multiple different operational states;
for each of the multiple PSUs, automatically determining an accumulated on-time for that PSU;
ranking the multiple PSUs based on the accumulated on-time determined for each PSU; and
automatically changing the operational state of at least one of the PSUs based at least on the ranking of the multiple PSUs.

2. A method according to claim 1, wherein changing the operational state of a PSU comprises at least one of:
switching the PSU from an “off” state to an “on” state; and
switching the PSU from an “on” state to an “off” state.

3. A method according to claim 1, wherein:
an “off” state of a PSU includes any state in which the PSU is not supplying power to the information handling system; and
an “on” state of a PSU includes any state in which the PSU is supplying power to the information handling system.

4. A method according to claim 1, wherein the steps of automatically determining an accumulated on-time for that PSU, ranking the multiple PSUS, and automatically changing the operational state of at least one of the PSUs are performed by a chassis management controller of the information handling system.

5. A method according to claim 1, comprising:
based on the ranking of the multiple PSUs, identifying the PSU having the lowest accumulated on-time and the PSU having the highest accumulated on-time; and
wherein automatically changing the operational state of at least one of the PSUs comprises turning on the identified PSU having the lowest accumulated on-time and turning off the identified PSU having the highest accumulated on-time.

6. A method according to claim 1, wherein:
the multiple PSUs include a number (y) of spare PSUs greater than one; and
the method further comprises:
identifying the y PSUs having the lowest accumulated on-time and the y PSUs having the highest accumulated on-time; and
wherein automatically changing the operational state of at least one of the PSUs comprises turning on the identified y PSUs having the lowest accumulated on-time and turning off the identified y PSUs having the highest accumulated on-time.

7. A method according to claim 1, further comprising automatically repeating the steps of automatically determining an accumulated on-time for that PSU, ranking the multiple PSUs, and automatically changing the operational state of at least one of the PSUs at regular time intervals.

8. An information handling system, comprising:
multiple power supply units (PSUs), each PSU maintained in one of multiple different operational states; and
a chassis management controller (CMC) coupled to each of the PSUs and configured to:
maintain each of multiple PSUs in one of multiple different operational states;
for each of the multiple PSUs, automatically determine an accumulated on-time for that PSU;
rank the multiple PSUs based on the accumulated on-time determined for each PSU; and
automatically change the operational state of at least one of the PSUs based at least on the ranking of the multiple PSUs.

9. An information handling system according to claim 8, wherein changing the operational state of a PSU comprises at least one of:
switching the PSU from an “off” state to an “on” state; and
switching the PSU from an “on” state to an “off” state.

10. An information handling system according to claim 8, wherein:
an “off” state of a PSU includes any state in which the PSU is not supplying power to the information handling system; and
an “on” state of a PSU includes any state in which the PSU is supplying power to the information handling system.

11. An information handling system according to claim 8, wherein the steps of automatically determining an accumulated on-time for that PSU, ranking the multiple PSUs, and automatically changing the operational state of at least one of the PSUs are performed by a chassis management controller of the information handling system.

12. An information handling system according to claim 8, comprising:
based on the ranking of the multiple PSUs, identifying the PSU having the lowest accumulated on-time and the PSU having the highest accumulated on-time; and
wherein automatically changing the operational state of at least one of the PSUs comprises turning on the identified PSU having the lowest accumulated on-time and turning off the identified PSU having the highest accumulated on-time.

13. An information handling system according to claim 8, wherein:
the multiple PSUs include a number (y) of spare PSUs greater than one; and
the method further comprises:
identifying the y PSUs having the lowest accumulated on-time and the y PSUs having the highest accumulated on-time; and
wherein automatically changing the operational state of at least one of the PSUs comprises turning on the identified y PSUs having the lowest accumulated on-time and turning off the identified y PSUs having the highest accumulated on-time.

14. An information handling system according to claim 8, further comprising automatically repeating the steps of automatically determining an accumulated on-time for that PSU, ranking the multiple PSUs, and automatically changing the operational state of at least one of the PSUs at regular time intervals.

15. Logic instructions for wear leveling in an information handling system including multiple power supply units (PSUs), the logic instructions embodied in tangible computer readable media and executable by a processor, comprising:
instructions for maintaining each of multiple PSUs in one of multiple different operational states;
instructions for automatically determining an accumulated on-time for each of the multiple PSUs;
instructions for ranking the multiple PSUs based on the accumulated on-time determined for each PSU; and
instructions for automatically changing the operational state of at least one of the PSUs based at least on the ranking of the multiple PSUs.

16. Logic instructions according to claim 15, wherein changing the operational state of a PSU comprises at least one of:
switching the PSU from an “off” state to an “on” state; and
switching the PSU from an “on” state to an “off” state.

17. Logic instructions according to claim 15, wherein:
an “off” state of a PSU includes any state in which the PSU is not supplying power to the information handling system; and
an “on” state of a PSU includes any state in which the PSU is supplying power to the information handling system.

18. Logic instructions according to claim 15, wherein the steps of automatically determining an accumulated on-time for that PSU, ranking the multiple PSUS, and automatically changing the operational state of at least one of the PSUs are performed by a chassis management controller of the information handling system.

19. Logic instructions according to claim 15, further comprising:
instructions for identifying the PSU having the lowest accumulated on-time and the PSU having the highest accumulated on-time based on the ranking of the multiple PSUs; and
automatically turning on the identified PSU having the lowest accumulated on-time and turning off the identified PSU having the highest accumulated on-time.

20. Logic instructions according to claim 15, wherein:
the multiple PSUs include a number (y) of spare PSUs greater than one; and
further comprising instructions for:
identifying the y PSUs having the lowest accumulated on-time and the y PSUs having the highest accumulated on-time; and
automatically turning on the identified y PSUs having the lowest accumulated on-time and turning off the identified y PSUs having the highest accumulated on-time.
